(19) United States
(12) Patent Application Publication
(10) Pub. No.: US 2007/0272049 A1
(43) Pub. Date: Nov. 29, 2007

(54) Steering Column Assembly Comprising A Steering Column The Tilt And Length Of Which Can Be Modified

(76) Inventors: Fred Eggers, Buxtehude (DE); Marcel Erang, Wilstedt (DE); Torsten Harms, Hamburg (DE); Holger Kittler, Hamburg (DE); Sven Sagner, Hamburg (DE)

Correspondence Address: KENYON & KENYON LLP, ONE BROADWAY, NEW YORK, NY, 10004, US

(21) Appl. No.: 10/571,309

(22) PCT Filed: Aug. 13, 2004
(86) PCT No.: PCT/EP04/09110

§ 371 Date: Dec. 26, 2006

(30) Foreign Application Priority Data
Sep. 10, 2003 (DE) 103 41 693.5
May 21, 2004 (DE) 10 2004 024 876.1

(51) Int. Cl. B62D 1/18

(52) U.S. Cl. 74/493

(57) ABSTRACT

In a steering column arrangement having a bracket which is arranged fixedly on the vehicle, a steering column which has a casing tube and a steering spindle which is mounted rotatably therein, the steering column is configured so as to be adjustable in its inclination and length, and clamping device(s) are provided for fixing the steering column. In order to configure the steering column to be safer while maintaining comfort functions, the steering column is connected with the clamping device(s) to the bracket via a bracket slide which is mounted displaceably on the bracket, and locking device(s) being provided between the bracket slide and the bracket.

### FIELD OF THE INVENTION

The present invention relates to a steering column arrangement.

### BACKGROUND INFORMATION

In modern vehicle engineering, steering columns are configured such that their inclination and length can be changed for reasons of comfort. As a result, they can be adjusted to the individual requirements of a driver. Clamping devices are provided for fixing the steering column in its position. The clamping devices are designed such that they block the capability of changing the position of the steering column reliably and permanently. This is true, in particular, for the case in which a force which acts in the axial direction acts on the steering column, such as in the event of an accident. Secondly, the clamping devices have to be designed such that they permit a change in the position of the steering column simply when required. A steering column of this type is described, for example, European Published Patent Application No. 0 802 104. The steering column has a bracket which is fixed to the vehicle and on which a clamping device in the form of lamellae is mounted. The steering column is connected via the clamping device to a bracket which is fixed to the vehicle. In an open position of the clamping device, it is possible to displace the steering column with respect to the bracket. In a closed position of the clamping device, the steering column is fixed with respect to the bracket.

In order to design steering column arrangements to be safe in the event of a vehicle collision, a steering column which cannot be adjusted in positional terms is fastened to a bracket which is arranged fixedly on the vehicle, such that, in the case of an accident, an axial displacement of the steering column relative to the bracket is made possible with the absorption of energy. Reference is made in this regard to German Published Patent Application No. 37 20 320, for example, in which a steering column arrangement with a bracket which is arranged fixedly on the vehicle is apparent. Furthermore, a nonadjustable steering column is described which is connected to the bracket via what is referred to as a hoop. The hoop and the bracket are connected to one another via bolts. The bolts engage into slot holes which are made in the hoop and which, in the case of an accident, make it possible for the hoop to be displaced relative to the bracket with absorption of energy. However, it is not apparent how the hoop is fixed relative to the bracket during normal use of the steering column arrangement.

### SUMMARY

Example embodiments of the present invention may provide a steering column arrangement, in which the safety of vehicle occupants may be increased and reliable use of the steering column arrangement may be ensured while maintaining comfort functions.

According to example embodiments of the present invention, a steering column arrangement includes a bracket which is arranged fixedly on the vehicle, and the steering column is configured so as to be adjustable in its inclination and length for reasons of comfort. In order to fix the steering column in its position, clamping device(s) are additionally provided. In order to increase the safety of vehicle occupants in the case of a crash, a bracket slide is arranged between the bracket which is arranged fixedly on the vehicle and the steering column having the clamping device(s), which bracket slide is connected to the bracket such that a linear displacement of the bracket slide is possible along the bracket. A locking device is provided between the bracket slide and the bracket. The locking device makes it possible that the steering column arrangement may be locked in a predefined position with respect to the bracket. It is possible that the predefined position of the steering column is the position which the steering column assumes during normal use.

According to an exemplary embodiment, the locking device may be released if a force which is applied to the steering column in the axial direction is exceeded, as a result of which it is possible for the bracket slide with the steering column and the clamping device to be displaced relative to the bracket. It is possible that the predefined amount of force is oriented toward a crash force, so that, for example, in the case of a crash if a force which acts in the axial direction is applied to the steering column, the steering column is displaced at exactly that instant, at which possible loads on the occupant have become excessively great. In this manner, it may be possible to increase the safety of vehicle occupants.

The locking device may be in the form of a sleeve which is connected fixedly either to the bracket or to the bracket slide and is connected releasably to the respective other part of the steering column arrangement. A fixed connection of this type may be produced, for example, by a rivet. However, all other types of connections are also possible which connect the sleeve reliably to the corresponding steering column part, even in the case of the action of a great force. What is referred to as a tear-off pin may be used, for example, a releasable connection between the sleeve and the corresponding steering column part. Pins of this type are conventional and are generally formed of plastic. Other materials such as metals are also possible, however. A tear-off pin of this type extends both in the sleeve and in the part, with which the sleeve is connected releasably. The pin is oriented perpendicularly with respect to the action of the force and shears off from the sleeve and the corresponding steering column part at the connection point, if a force which is applied to the steering column part exceeds a predefined magnitude.

It is possible for the tear-off pin to be manufactured from a plastic having a definable material failure behavior. When a definable material failure behavior is mentioned, a material failure behavior is meant by this which may be predicted as a function of forces which are introduced perpendicularly into the pin. This may provide that the force may be set precisely, above which the steering column is displaced relative to the bracket.

The tear-off pin may have a constriction which extends around the radial circumference of the tear-off pin. The constriction may be a groove or a chamfer. The constriction may be arranged, for example, in the center of the tear-off pin. The tear-off pin has a defined diameter at the level of the constriction. This contributes to the tear-off pin failing at a precisely predictable force, with the result that the force may be set precisely, above which the steering column is displaced relative to the bracket. This plays a role, for example, when consideration is taken that the holes in the bracket slide and the sleeve which accommodate the tear-off pin may be subject to tolerances, with the result that, when the tear-off pin is introduced, it would acquire a different diameter without the constriction, depending on the tolerance of the hole. However, a different diameter has the consequence of different tear-off forces and thus different displacement instants of the steering column relative to the bracket.

The constriction may be arranged at the level of the tear-off pin, which level corresponds to a dividing plane between the bracket slide and the sleeve in the installed state. If the constriction is arranged at the level of this dividing plane, the crash force is directed directly at the correct point of the tear-off pin in a crash and reliable failure of the tear-off pin may be ensured.

According an exemplary embodiment in which the sleeve is connected fixedly to the bracket, the bracket slide has a receptacle which is adapted to the sleeve. A receptacle of this type may make it possible for the sleeve to be integrated into the bracket slide, with the result that it does not protrude, at least on the side which faces the bracket slide, and makes frictionless displacement of the bracket slide possible relative to the bracket. In addition, it may have to be ensured that the possibilities of adjusting the comfort of the steering column arrangement also have to be able to be carried out in a frictionless manner.

It is possible for a gap which exists between the receptacle and the sleeve to be filled with plastic by injection molding. This feature serves to produce a playfree connection between the bracket slide and the sleeve, in order that no undesirable relative movements and any possible noise associated with the latter may occur during use of the steering column. The filling operation by injection molding may be performed after the assembly of the steering column arrangement, with the result that a play which is initially present between the bracket slide and the sleeve may be used to compensate for assembly tolerances.

Instead of a tear-off pin, it is possible for the sleeve to be provided with semicircular holding chambers along its circumference. Corresponding holding chambers may be provided in the receptacle along its edge which faces the sleeve. It is possible for the corresponding holding chambers of the sleeve and the receptacle to have their shape selected and to be arranged with respect to one another such that, at least in regions, they enclose a space with a substantially round cross-section. If a round cross-section is mentioned in this context, a section is meant in a plane which corresponds to a line of contact between the bracket slide and the bracket. If a gap which exists between the bracket slide or between the receptacle of the bracket slide and the sleeve is then filled with plastic by injection molding and the corresponding holding chambers of the sleeve and the receptacle are also filled in the process, “quasi-tear-off pins” are produced at these locations. The plastic may also be selected such that it has a predefinable material failure behavior. A force may accordingly be set precisely via the selection of the material and the shape and dimensions of the holding chambers or the gap, above which force the steering column arrangement is displaced relative to the bracket.

In the following, example embodiments of the present invention are explained in greater detail with reference to the appended Figures.

### BRIEF DESCRIPTION OF THE DRAWINGS

FIG. 1 is a plan view of a steering column arrangement according to an example embodiment of the present invention.

FIG. 2 is a side view of the steering column arrangement illustrated in FIG. 1.

FIG. 3 illustrates a bracket with a bracket slide of a steering column arrangement illustrated in FIG. 1, before an impact.

FIG. 4 illustrates a bracket with a bracket slide of a steering column arrangement illustrated in FIG. 1, after an impact.

FIG. 5 is a schematic cross-sectional view through a bracket and a bracket slide at the level of a sleeve.

FIG. 6 is a cross-sectional view through a bracket slide and a sleeve at the level of a tear-off pin.

FIG. 7 is a plan view of a bracket slide with a sleeve.

### DETAILED DESCRIPTION

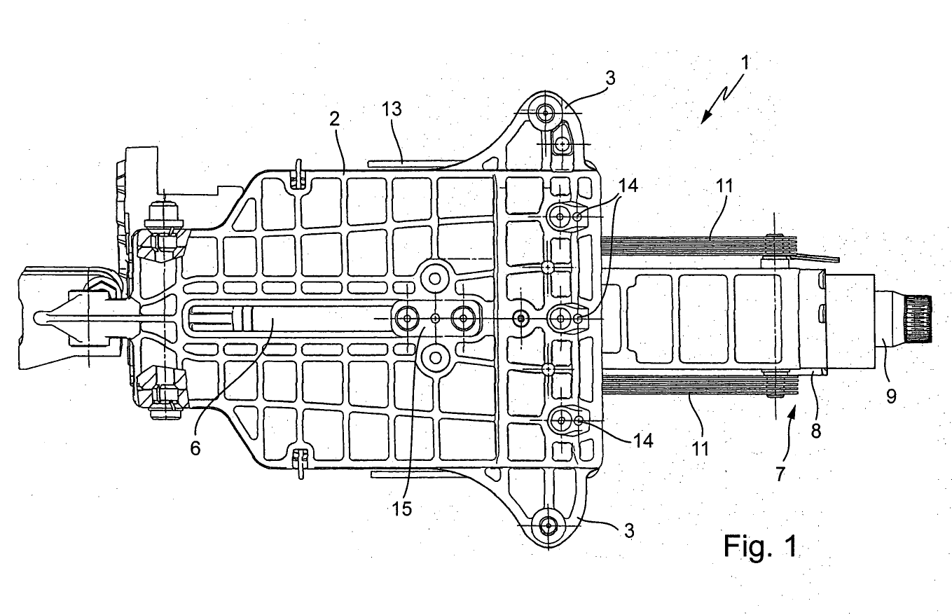

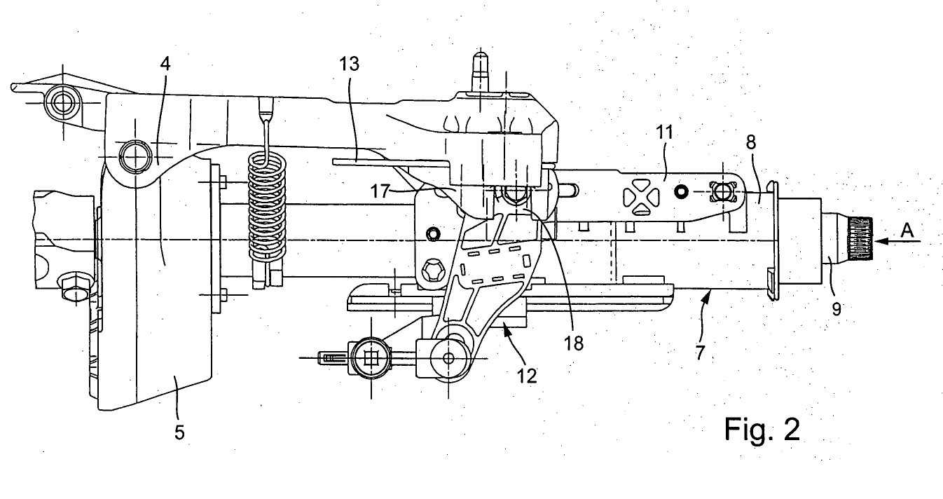

FIG. 1 illustrates a steering column arrangement 1. The steering column arrangement 1 has a bracket 2. The bracket 2 has a substantially rectangular cross-section. It has receptacles 3 for fastening devices. The bracket 2 is mounted via the fastening devices on a vehicle. Furthermore, receptacles 4 are provided (cf., FIG. 2) which serve to accommodate a further fastening element. The fastening element which is arranged in the receptacle 4 serves to fasten a sleeve 5. Furthermore, the bracket 2 has a slot 6 which extends over a large part of the length of the bracket 2. The function of the slot 6 will be explained in greater detail in the following text.

Furthermore, the steering column arrangement 1 has a steering column 7 with a casing tube 8 and a steering column 9 which is mounted rotatably in the casing tube 8. The steering column 9 serves for holding a steering wheel and for transmitting a rotational movement which is imparted to the steering wheel by a driver to a steering gear mechanism.

In addition, lamella assemblies 11 are illustrated in FIG. 1 which are arranged on both sides of the casing tube 8 and via which it is possible to fix the steering column in a defined position. The lamella assemblies 11 interact with a clamping apparatus 12. Fixing and releasing may be carried out by increasing and reducing the pressure which prevails between the lamellae 11, and displacement or fixing of the steering column may thus be brought about.

A bracket slide 13 is arranged below the bracket 2. The bracket slide 13 is connected to the bracket 2 via fastening elements 14 and a sliding block 15. The dimensions of the sliding block 15 are adapted to the dimensions of the slot 6, and the sliding block 15 is arranged in the slot 6. The sliding block 15 is connected to the bracket slide 13 via suitable fastening elements, such as screws 16. As illustrated in FIG. 2, the clamping apparatus 12 is arranged on the bracket slide 13. For this purpose, the bracket slide 13 has limbs 17 which are arranged at an angle to it. The limbs 17 have receptacles 18, via which a connection may be produced between the bracket slide 13 and the clamping apparatus 12.

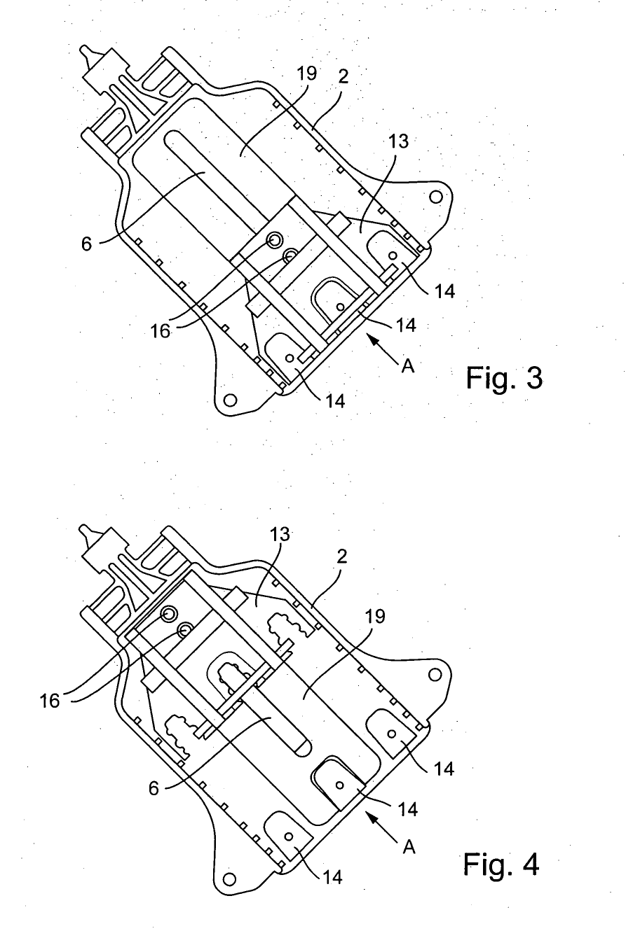

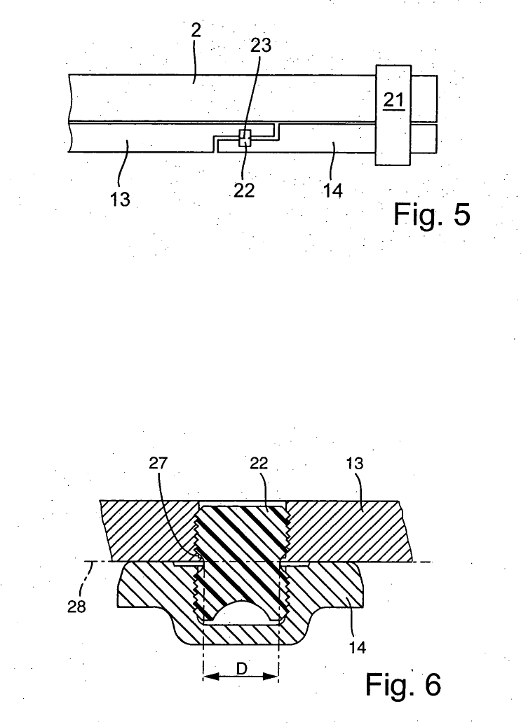

In the following text, a method of operation of the steering column arrangement 1 is explained in greater detail in conjunction with FIGS. 3 and 4. If, in the case of a crash, a force A acts on the steering column arrangement 1 according to the arrow A, and the force A exceeds a predefined magnitude, the force A is transmitted into the bracket slide 13 via the steering spindle 9, the casing tube 8 and the clamping apparatus 12. The clamping apparatus 12 is designed such that it withstands a predefined magnitude of force, that is to say it holds the steering column 7 in its position despite this force. If the force A then exceeds a predefined magnitude, the fastening elements 14 are released between the bracket slide 13 and the bracket 2, which results in a movement of the bracket slide 13 then becoming possible relative to the bracket 2. The fastening elements 14 between the bracket slide 13 and the bracket 2 are explained in greater detail with reference to FIGS. 5 and 6.

The bracket slide 13 performs a defined, linear movement which is determined by the slot 6, as a result of the interaction of the sliding block 15 which is connected to the bracket slide 13 and the slot 6 of the bracket 3. Accordingly, the steering column arrangement 1 provides two possibilities for displacing the steering column 7 in the vehicle. There is one possibility after release of the clamping apparatus 12 for the purpose of adjusting the steering column 7 for comfort. There is a further possibility after release of the fastening elements 14 in the case of a crash. As a result of two separate displacement or adjustment possibilities being provided, it is possible to set the resistances differently which have to be overcome during displacement of the steering column arrangement 1.

FIG. 3 illustrates a bracket 2 with a bracket slide 13, to be precise before the action of the force A on the steering column arrangement 1. For clarity, an illustration of the steering column 7 which is connected to the bracket slide 13 and of the clamping apparatus 12 is omitted. However, both the fastening elements 14 between the bracket slide 13 and the bracket 2 and also the fastening elements 16 for the sliding block 15 are illustrated in FIG. 3. Furthermore, the slot 6 in the bracket 2 is illustrated, the sliding block 15 being guided by the slot 6.

If, in the case of a crash, a force A acts on the steering column arrangement 1 and the latter acts on the bracket slide 13 via the steering spindle 9, the casing tube 8 and the clamping apparatus 12, the fastening elements 14 are released and allow a movement of the bracket slide 13 with respect to the bracket 2. FIG. 4 illustrates a bracket slide 13 after a movement of this type. The bracket slide 13 is displaced along the slot 6 in the direction of the introduction of force.

FIG. 5 diagrammatically illustrates a section through a bracket 2 and a bracket slide 13 at the level of a locking device. The locking device has the form of a sleeve 14. The sleeve 14 is connected fixedly to the bracket 2 via a rivet 21. A tear-off pin 22 is provided between the bracket slide 13 and the sleeve 14. The tear-off pin is formed of plastic and, if a force which exceeds a predefined magnitude is applied to the bracket slide 13, tears at the level of the dividing line 23.

FIG. 6 is a cross-sectional view through the bracket slide 13 and the sleeve 14 at the level of a tear-off pin 22. The tear-off pin 22 has a constriction 27 which extends radially around the circumference of the tear-off pin 22. The constriction 27 has the effect that the tear-off pin 22 has a defined diameter D. The diameter D is independent of whether the diameter in the remaining region of the tear-off pin 22 changes during assembly. The constriction 27 is arranged at the level of the dividing plane 28 between the bracket slide 13 and the sleeve 14. If the extent of the constriction 27 exceeds a certain amount, a further aspect results during the assembly of the tear-off pin 22. The position of the tear-off pin 22 and its constriction 27 does not have to be set so precisely relative to the dividing plane 28, as there are a plurality of possibilities to assume the position. It is also possible to provide the tear-off pin 22 with a longitudinal groove which may ensure that the air in the hole of the sleeve 14 may escape in a simple manner during assembly.

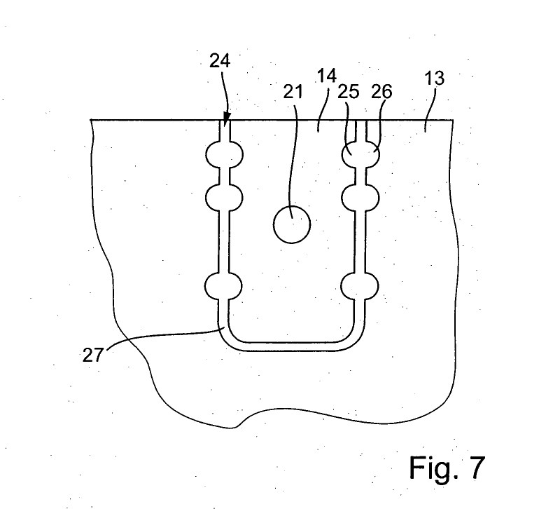

FIG. 7 illustrates a further exemplary embodiment of a sleeve 14. A detail from a bracket slide 13 is illustrated. The bracket slide 13 has a receptacle 24. The contour of the receptacle 24 is adapted to the contours of the sleeve 14. The sleeve 14 has holding chambers 25 along its circumference. As illustrated in FIG. 6, the holding chambers 25 have a semicircular shape. The receptacle 24 has holding chambers 26 along its edge which faces the sleeve 14. The holding chambers 25 of the sleeve and the holding chambers 26 of the receptacle are selected in terms of their size and their position such that they enclose a space which has a substantially round cross-section. Furthermore, the dimensions of the sleeve and the receptacle are selected such that a gap 27 is produced between them. The gap 27 with the holding chambers 25, 26 is filled with plastic. In the case of a collision and a force which acts on the bracket slide, the plastic tears in accordance with the tear-off pin 22 which is described with reference to FIG. 5, and releases the bracket slide 13 with respect to the bracket 2.

1-14. (canceled)

15. A steering column arrangement, comprising:
a bracket fixedly arrangeable on a vehicle;
a steering column that includes a casing tube and a steering spindle mounted rotatably in the casing tube, the steering column adjustable in inclination and length;
a clamp device adapted to fix the steering column;
a bracket slide mounted displaceably on the bracket, the steering column with the clamp device connected to the bracket by the bracket slide; and
a lock device arranged between the bracket slide and the bracket.

16. The steering column arrangement according to claim 15, wherein the lock device is releasable in response to a force applied to the steering column in an axial direction that exceeds a predefined magnitude, the bracket slide displaceable relative to the bracket in accordance with the force.

17. The steering column arrangement according to claim 15, wherein the lock device includes at least one sleeve connected fixedly to the bracket.

18. The steering column arrangement according to claim 17, wherein the sleeve is connected releasably to the bracket slide.

19. The steering column arrangement according to claim 17, wherein the sleeve is connected fixedly to the bracket by a rivet.

20. The steering column arrangement according to claim 18, wherein the sleeve is connected releasably to the bracket slide by a tear-off pin.

21. The steering column arrangement according to claim 20, wherein the tear-off pin is formed of a plastic having a definable material failure behavior.

22. The steering column arrangement according to claim 20, wherein the tear-off pin includes a constriction that extends around a radial circumference of the tear-off pin.

23. The steering column arrangement according to claim 22, wherein the constriction is arranged at a level of the tear-off pin that corresponds to a dividing plane between the bracket slide and the sleeve in an installed state.

24. The steering column arrangement according to claim 17, wherein the bracket slide includes a receptacle adapted to the sleeve.

25. The steering column arrangement according to claim 24, wherein a gap between the receptacle and the sleeve is filled with injection-molded plastic.

26. The steering column arrangement according to claim 25, wherein the sleeve includes holding chambers along a circumference.

27. The steering column arrangement according to claim 26, wherein the receptacle includes holding chambers corresponding to the sleeve and arranged along an edge that faces the sleeve.

28. The steering column arrangement according to claim 27, wherein the holding chambers of the sleeve and the receptacle are arranged with respect to one other to, at least in regions, enclose a space with a substantially round cross-section.

29. A steering column arrangement, comprising:
bracket means fixedly arrangeable on a vehicle;
steering column means that includes a casing tube and a steering spindle mounted rotatably in the casing tube, the steering column means adjustable in inclination and length;
clamping means for fixing the steering column;
bracket slide means mounted displaceably on the bracket means, the steering column with the clamp means connected to the bracket means by the bracket slide means; and
locking means arranged between the bracket slide means and the bracket means.

30. A motor vehicle, comprising:
a steering column arrangement including:
a bracket fixedly arranged on the vehicle;
a steering column that includes a casing tube and a steering spindle mounted rotatably in the casing tube, the steering column adjustable in inclination and length;
a clamp device adapted to fix the steering column;
a bracket slide mounted displaceably on the bracket, the steering column with the clamp device connected to the bracket by the bracket slide; and
a lock device arranged between the bracket slide and the bracket.
